(19) United States
(12) Patent Application Publication
(10) Pub. No.: US 2014/0029103 A1
(43) Pub. Date: Jan. 30, 2014

(54) OPTICAL BLACK SURFACE

(71) Applicant: William Frank Budleski, Raleigh, NC (US)

(72) Inventor: William Frank Budleski, Raleigh, NC (US)

(21) Appl. No.: 13/556,302

(22) Filed: Jul. 24, 2012

(51) Int. Cl. G02B 1/10

(52) U.S. Cl. 359/584

(57) ABSTRACT

The present invention relates to optical black material which absorbs light. The device has a plurality or matrix of cells, each cell by a specular and diffuse absorbing material generating mostly specular reflection which is captured.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a material having a light absorbing quality. In particular the present invention relates to material having the ability to have a high absorption of light shined on it.

2. Description of Related Art

Optical coatings and surfaces are known and are used in instances where low light reflectivity, or conversely high light absorption, is required, that is, surfaces which absorb a substantial portion of the electromagnetic radiation, especially in the solar spectrum, to which they are exposed. Historically, the highest absorption is achieved with black coatings and surfaces. Uses for optical black coatings and surfaces include the interiors of solar telescopes, space observatories, binoculars, camera bodies, lenses, projection lighting, lighting, spot lights, laser based measurement systems, vehicle dashboard anti-glare mat, magician backgrounds, and the like, where reflected radiation will interfere with the radiation being observed or measured and solar panels where radiation, such as thermal solar energy, is absorbed for conversion into some other form of energy, such as heat or electricity.

There has been much development work in the area of providing and developing devices having a material or surface finish such that they absorb an extremely high percentage of microwaves, ultra-violet, visible and infrared radiation, and therefore only a very low percentage of such radiation is reflected therefrom. Some of the development work has involved processes for treating the surface of the body involved to improve its optical character, and some has involved coatings and coating processes which result in improved optical characteristics for the surface of the body. Development work has generally involved to have the reflected light from the surface finish diffused.

Among the known coatings for producing optical, especially black, surfaces are the organic black coatings and the so-called high temperature black coatings. Known organic coatings include the 3M (Minnesota Mining and Manufacturing Company) Nextel black velvet coating or print which has a composition by weight of approximately 16% pigment and 84% organic vehicle (basically a polyester base material). The pigment comprises approximately 20% carbon black and approximately 80% silicon dioxide. This material is commonly used for coatings in optical instruments such as telescope tubes, camera housings, vacuum chamber walls, etc.

In addition to the 3M Nextel black velvet paint, another well-known high absorbent of visible and infrared radiation is Parson's black. Parson's black consists of an alkyd lacquer containing carbon black. The carbon black, which is a powdery material, is adhered to the surface of a body to give that surface a high radiation absorption capability. Parson's black is, in general, a better visible and infrared absorbent than 3M Nextel black velvet paint.

Other optically black organic coatings have been developed, but they differ basically in the type of vehicle employed, such as epoxy and acrylic base coatings. None of the other organic black coatings, to applicant's knowledge, achieve the high degree of absorbency of visible and infrared radiation as does the 3M Nextel black velvet paint and Parson's black.

The 3M Nextel black velvet paint and Parson's black, both of which, as noted above, are known for their high absorption capability of visible and infrared radiation, have a substantial shortcoming in their lack of durability. The 3M black velvet paint is subject to chipping after moderate temperature exposure and hydrocarbon outgassing, both of which detrimentally affect the desirability of the product. In addition, because the organic binder will degrade at elevated temperatures, the organic coatings are restricted to low temperature applications. Further, Parson's black, which contains a relatively high percentage of powdery carbon black, also lacks durability, being very easily removed from any surface on which it is applied.

The so-called high temperature black coatings are not entirely free from the problems of organic binders, since they basically comprise an organic material having inorganic components which are deposited as a residue. An example is the silicone resin based “high temperature” coating, which is commercially available. The inorganic surface is formed by coating a silicone resin on the substrate which is to have the optical surface, heating the coating to about 600 degrees F. to 1000 degrees F. to burn-off the organic binder which leaves an inorganic residue, and then heating the residue to in excess of 1000 degrees F. to sinter the residue and thus form an inorganic layer on the substrate. Such a coating is inorganic and so will generally avoid the off-gassing problems associated with organic coatings, but such a coating process requires a large amount of expensive high temperature processing equipment, as well as processing steps, and if not properly heat treated, an organic residue may remain. Further, in order to avoid the formation of heat scale, which is associated with ferrous alloys during the high temperature treatment step, e.g., on the inside of tubes which are being optically coated, a means is required to protect the inside of the tubes, such as an inert gas purge inside the tubes or the like treatment, which only adds to the complexity and expense of the process.

Silicate coatings, such as sodium and potassium silicate, are well known for such purposes as high temperature resistance and corrosion resistance. Silicate coatings normally are not noted for their optical qualities, and in fact, are considered to have only average absorptive or reflectivity levels. Often, silicate coatings are used as a primer, i.e., a protective coating which precedes the ultimate surface coating of paint. Further, while silicate coatings are inorganic, and thus do not suffer from the problems of organic coatings, they are known, depending upon the formulation, to suffer from problems of durability and moisture resistance. Examples of silicate coatings are U.S. Pat. Nos. 2,076,183; 2,711,974; 3,416,939; 3,615,282; 3,620,791; and 3,769,050; and British Pat. No. 643,345.

U.S. Pat. No. 2,076,183 is of particular note because it discloses a heat resistant, permanent black, sodium silicate finish. However, such a coating would not be considered an optical black coating in that it would not have a sufficiently high solar absorptive, especially as compared to, e.g., 3M Nextel velvet black. Thus, the black of U.S. Pat. No. 2,076,183 would only be a general purpose black.

In U.S. Pat. No. 4,150,191 a coating for a flat surface is described which contains alkali metal silicate in addition to black pigment. Thus, a need exists for an optical coating and surface which has a high absorptive, and thus, a low reflectance of electromagnetic radiation, especially in the solar spectrum, and does not suffer from problems such as off-gassing or chipping or high temperature degradation.

### BRIEF SUMMARY OF THE INVENTION

The present invention produces a superior optical black surface by creating a matrix of cells with the majority of light entering the cell either specularly reflected or directly absorbed.

Accordingly, in one embodiment of the invention there is a device having an optical black surface for the absorption of electromagnetic energy having a wavelength between about 10 nm and about 1 meter comprising:
a) a matrix of cells each cell having at least two opposing walls, each opposing wall having a wall surface facing the inside of the cell each and a sharp top surface, each cell having a bottom and a depth;
b) the distance between the sharp top surface of the at least two opposing walls is no greater than 130 percent the depth;
c) a center axis of each wall facing in the same direction;
d) the wall surface and bottom of the cell being a black color and being of a specular and diffuse absorbing material generating mostly specular reflection; and
e) the bottom of the cell being of an angle other than perpendicular to the walls of the cell.

### BRIEF DESCRIPTION OF THE DRAWINGS

FIGS. 1a and 1b are examples of individual cells not in a matrix.

FIG. 2 shows various cell patterns and two opposing devices.

FIG. 3 is a saw-tooth pattern with a flat angled bottom and planar top or sharp shaft edge top.

FIG. 4 is a saw-tooth pattern where the sharp tops are at different levels.

FIG. 5 is an accordion fold matrix pattern.

FIG. 6 is a honeycomb pattern with four sided cells angled.

FIG. 7 shows another honeycomb pattern with the four sided cells angled.

FIG. 8 shows a four sided honey comb pattern with an angled bottom to each cell.

FIG. 9 is a perspective of a honeycomb pattern matrix with six sided cells.

FIG. 10 is a single wall from a cell being of a glossy clear material with black carbon fibers on the inside.

FIGS. 11a, 11b, and 11c are views of cells having curved walls.

FIG. 12 is a perspective view of pyramidal cell walls.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The terms “about” and “essentially” mean ±10 percent.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein “optical black device” refers to a structure having a surface which absorbs a high degree of electromagnetic spectrum energy from a light that shines on it. In general light from 10 nm to 1 meter is included in the term light and includes UV light, visible light, infrared light and microwaves. One shining a light from any or all of the included spectra would experience little to no measurable reflected light. While no device is absolutely absorptive the present invention represents a higher degree of energy absorption than previous optical black surfaces. That is especially true when compared with flat coated surfaces.

As used herein a “matrix of cells” refers to a collection (plurality) of connected cells arranged in linear fashion or in both rows and columns. A cell will have at least two opposing walls, each top of the walls having a sharp top surface, the cell further having a bottom and a depth. The walls surfaces can be parallel, bowed, curved or angles, for example in a V shape. The depth is the distance between the sharp top surface of the wall and the lowest portion of the bottom of the cell. A cell can be open at one or both sides as in the linear saw-tooth cells or accordion type arrangement or can be completely enclosed such as the honeycomb type matrix of cells depicted in the figures. Note that where a cell has complete closed in sides and the walls form a circular top surface that would comprise an infinite number of opposing walls, i.e. any point on the circle has an opposing point on the other side of the cell. In determining how far apart the walls need to be the two or more walls need to have the sharp top of the wall be no farther apart than 130% the depth as measured above. There should be no limit on depth other than limited by the particular use of the optical black surface. However, in one embodiment walls are not further apart than about 0.001 mm, 0.01 mm, 0.1 mm, 0.5 mm, 1 mm, 10 mm or 100 mm. The sharp top surface of the walls can all be in the same plane (i.e. planar) or they can be of differing heights in other embodiments. The walls of the cells should be facing in the same direction. That is a center axis of each wall is parallel to all the other walls' center axis regardless of what direction the wall's surface is facing. Where one wall is two sides each side facing a different cell, the center axis of the wall is the common center axis as noted in the description of the figures which follow. In one embodiment the walls are their furthest apart at the sharp top surface of opposing walls. In another embodiment the walls are tapered in thickness from the shape top downward and in one angled at about 45 degrees, or from about 1 to 90 degrees. In one embodiment, the walls of the cells are curved or circular. In other embodiments the cells have 3, 4, 6, 8, or more walls each wall facing another wall or a single wall as in an old coiled windup clock spring or zigzag. The walls of the cells in one embodiment can be facing in random directions. The bottom of the cell is at an angle other then perpendicular to the side walls of the cell.

In one embodiment the center axis of the walls are perpendicular to the horizontal plane and in other embodiments the axis of the walls is angled from 15 to about 35 degrees (in one embodiment 30 degrees).

The top surface of each wall needs to be “sharp” that is having a very thin edge and brought to as sharp a point as is possible. In general in one embodiment the thickness of the wall at the tip surface (the top of the wall sharp edge radius) should be less than about 30% of the spacing between the walls to minimize edge reflection from the sharp radius. For example, a thin knife edge thickness is one embodiment of the thickness of the tip. The top surface of each wall can be in the same plane or in different planes.

As used herein “a black color and being of a specular absorbing material” refers to a combination of elements that the wall surface of each wall facing the center of the cell must have. This can be applied by paint, the material colored when manufacturing, an appliqué (mat or sheets), or the like. Black refers to the color or pigment of a black color i.e. very dark in color. Specular absorbing material refers to a material that has both specular reflection and light absorbing qualities, and as little as possible diffuse light reflection. In general that means the surface of the walls need to be glassy rather than matt or flat and absorb at least 5%, 10%, 20%, 30%, 40%, 50%, 60%, 70%, 80%, 90% or more of the light striking it and essentially specularly reflects most of the rest of the light with diffusion of light being from about 0% to no more that about 25%. Glossy materials such as glossy plastics in black clear plastics with black fibers or the like, or glossy black pigments or black chrome and the like are well known. Material such as black silicone high gloss rubber (e.g. a mat) could be used. The sharp edge radius can be such as ends of carbon fibers. The arrangement of cells using these types of materials gives the present invention its optical black properties. As shown in the figures, when light is shined toward a cell it hits a first surface and some light is absorbed and some specularly reflected (with little to none diffusely reflected). As the light hits other walls of the cell and the bottom more and more of the light is absorbed, the arrangement being such that light must bounce at least 2 times but 5, 6, 7, 8, 9, 10 times or more contemplated. Depending on how much is absorbed in each bounce, one can calculate how many bounces are needed to essentially have little to no light reflect out of the cell. For example, if as little as 70% of the light is absorbed on each bounce and if the light bounces 7 times, then the light is diminished to 0.024% of the original light amount. For example, more typically if 90% of the light is absorbed on each bounce and if the light bounces as light, 5 times, then the light is diminished to 0.001% of the original light amount. One viewing this disclosure can realize that the designer of a particular surface can determine the amount of absorbance with each bounce and design enough dimensions and surfaces to reduce the emitted light from the cell to 0.01% or less. Once again, the key is a specular surface that also absorbs. In one embodiment, the specular absorbing material is the same on all wall surfaces and bottoms. In other embodiments, different materials can be used between surfaces or between cells or both. In one embodiment there is a specular clear coating above black pigmented surface(s). In one embodiment the bottom surface is mirror like. One skilled in the art would be able to select appropriate materials in view of this disclosure.

As used herein the “bottom” of the cell is the lowest part of the cell. It can be the intersection of two wall surfaces or a separate surface or surfaces. Several examples are shown in the figures. In one embodiment the cell bottom is flat, in another embodiment it is a “V” shape. However, if more light bounces can be created, one skilled in the art can calculate where specular light will bounce and create enough surfaces to absorb a desired amount of light based on the absorbance of the surfaces. In another embodiment the bottom of the cell is angled from about 10 to about 40 degrees (in one embodiment 30 degrees) relative to a horizontal plane. In another embodiment, the bottom is “U” shaped. In another embodiment the bottom is of multiple angles or curves. The bottom of the cell is other than perpendicular to the cell walls.

The present invention optical black device can be utilized in a number of designs, such as, using the saw-tooth or accordion bellows arrangement with “V” or angled shaped bottoms to coincide with air flow on an aircraft to minimize air turbulent flow (drag) while absorbing a wide spectrum of energy. It can be used in cameras and can optionally be antistatic or purged by clean air to minimize accumulation of dust and other contaminants.

In one embodiment two opposing optical black devices are utilized to absorb light each from the opposing device (as shown in the figures).

Now referring to the figures, all cells are coated on the inside wall surfaces with black specular absorbing coating, material or the like. Because an absolute black material cannot be shown in a drawing it is assumed that the surfaces of the cells are so coated for purposes of disclosure.

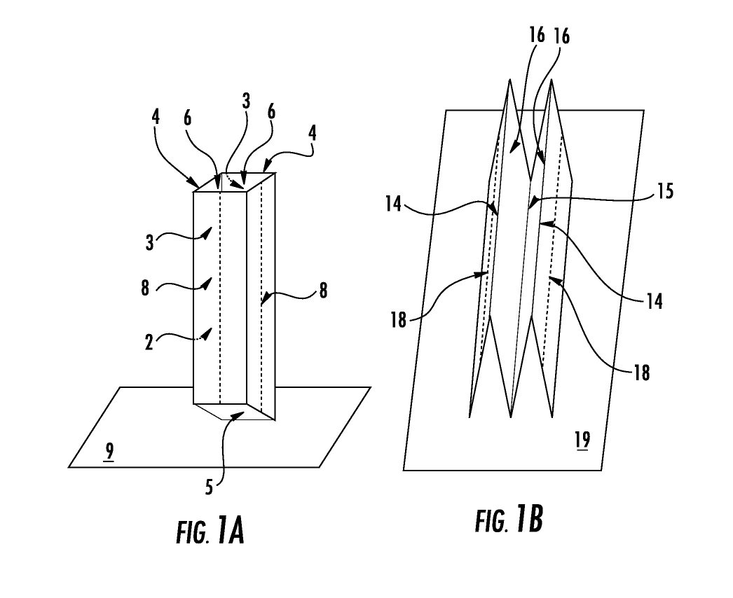

FIG. 1a is a single cell isolated from a matrix of cells wherein the sides are enclosed and showing two sets of opposing walls. The cell consists of a first set of opposing walls 2 and a second set of opposing walls 3. Each wall has a sharp top surface 4. The cell has an angled closed in bottom 5. Each wall has a surface 6 that faces the inside enclosed area of the cell. It can be seen that a center axis 8 of each wall is perpendicular to horizontal plane 9 and that each axis is parallel to the others.

FIG. 1b depicts a cell with two parallel walls and open sides. In this embodiment, the inside facing walls 16 form a V shape which shape forms a bottom 15 which is just a line. They also have sharp tops 14, but unlike the previous version walls facing inside 16 are not parallel. However the axis 18 of each wall is parallel and in this embodiment perpendicular to horizontal plane 19.

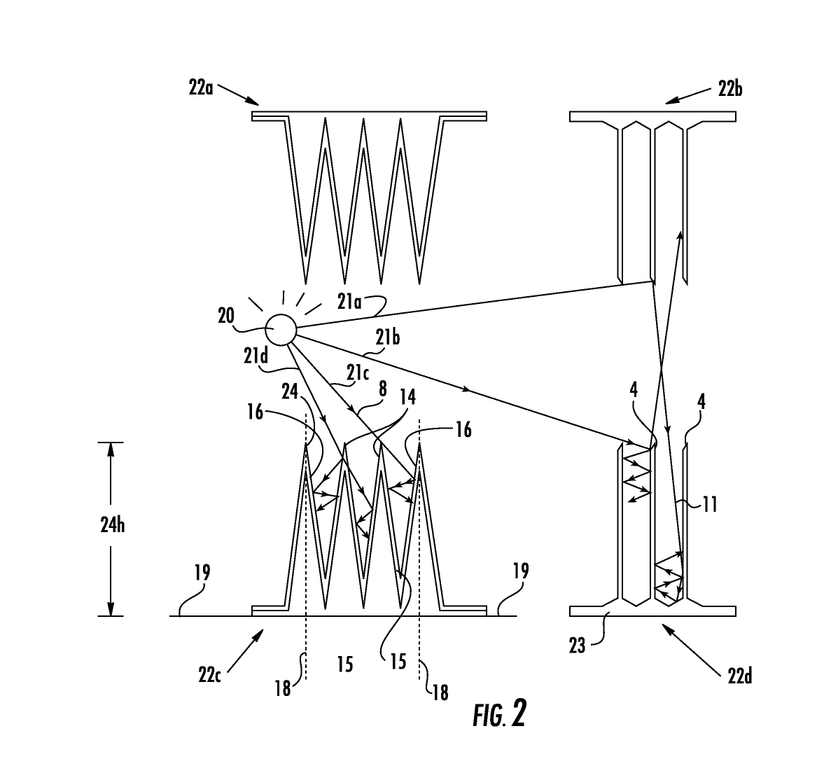

FIG. 2 shows two different sets as shown in FIG. 1a with a second device positioned opposite the first that is capable of catching whatever miniscule light escapes from whichever of the two devices is hit first by light 20.

In FIG. 2 light source 20 has light beams 21a, 21b, 21c and 21d which shine on the various devices of the invention 22a, 22b, 22c and 22d. As can be seen, light beams 21d, 21c, and 21b each enter a cell having a specular reflection, however, at each reflection a portion of the light energy is absorbed so that after 3 to 8 (more or less) bounces (depending on the absorption rate chosen) essentially all of the light energy is absorbed and little if any light escapes from inside the cell. Unlike previous devices that do not use specular surfaces, the multiple reflections are captured and little or no diffuse light is created and light escapes. In this view, one can see that cell depth 24h is at least 77 percent of cell width 24w. Cell 22d shows a different bottom design than FIG. 1a. It shows an angled bottom 23 which when a beam strikes the bottom 23, adds additional reflections, thus more absorption. To further reduce corner reflection from the bottom 23, a single angle instead of V bottom is used with the two bottom corners slightly under cutting the sides which will eliminate any bottom corner reflection. One skilled in the art at this point can see by determining the direction of the light entering the cells one can determine how many reflections will occur before light might escape. Considering the absorption during each reflection one can determine if that number of reflections is sufficient to prevent light escaping, and if not, adjust accordingly.

In this embodiment in can be seen that some of the light 21b bounces off an edge sharp top 4 and is reflected in to opposing cell matrix 22b thus capturing the remaining light. Likewise beam 21a reflects off of 22b and down into matrix 22d to be absorbed.

One again, while not shown, the surface of the walls that face one another are black and partially specularly reflect and at least partially or mostly absorb with little or no diffusion of light during the process.

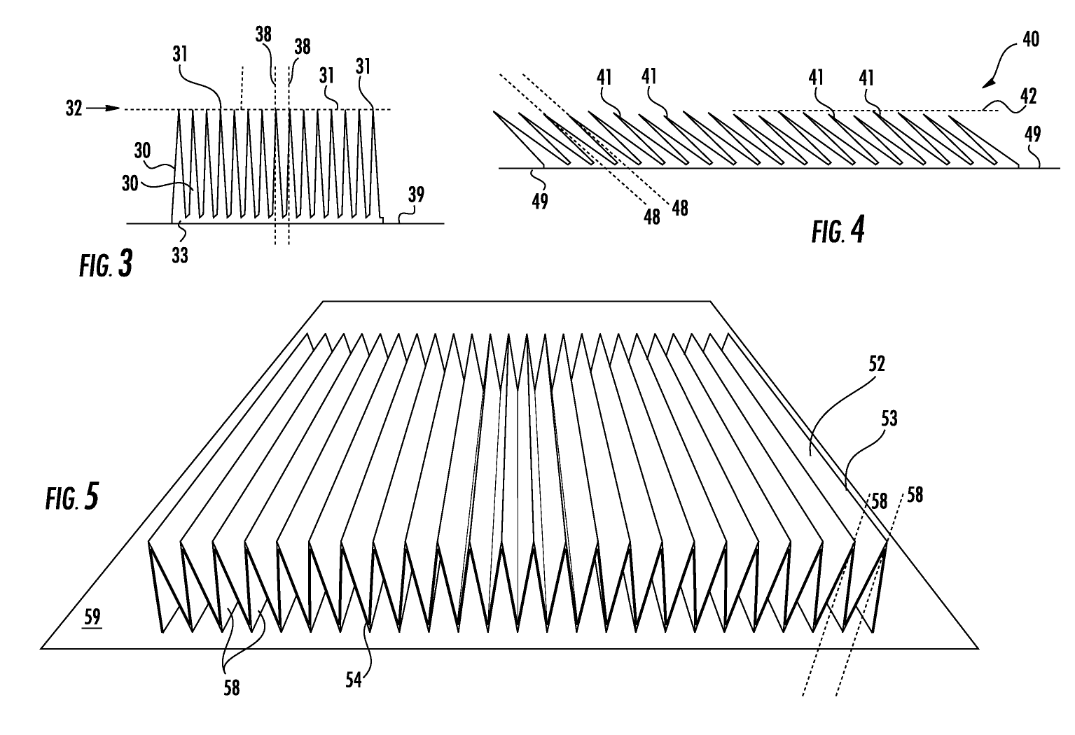

FIG. 3 depicts a saw tooth pattern 30 for an arrangement of cells in a side view. In this side view it can be seen that sharp top surface 31 are all at a horizontal plane 32. This saw tooth pattern shows a flat angle bottom 33 but other bottom shapes can be utilized. Once again, axis 38 point in the same direction and are perpendicular to horizontal plane 39.

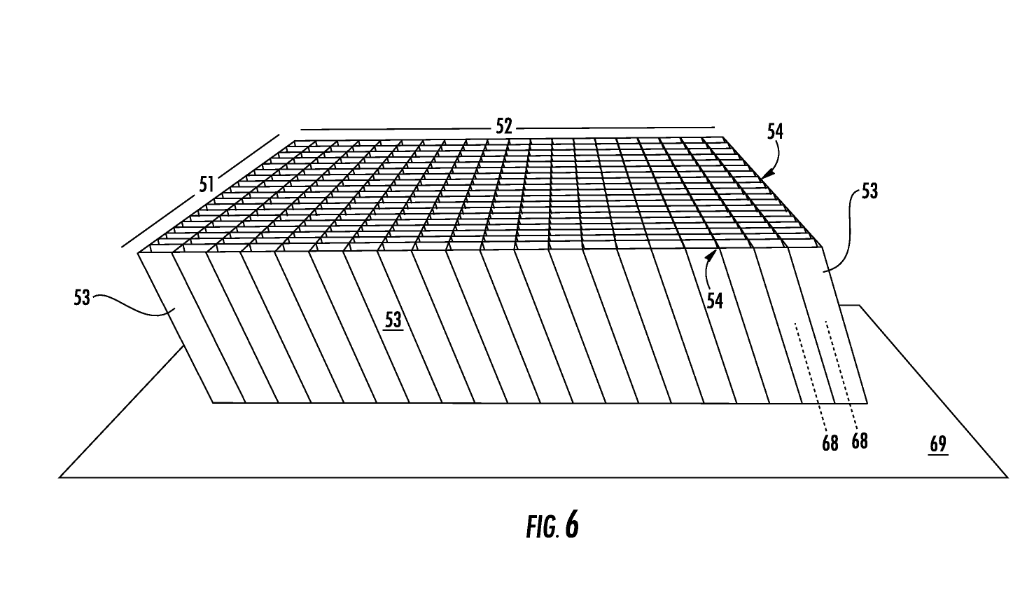

FIG. 4 depicts a saw tooth pattern 40 but where sharp tops 41 are not all on the same horizontal plane for example plane 42 only touches the tops of some of sharp tops 41. In addition axis 48 are parallel as in other embodiments but are at an angle to horizontal plane 49.

Once again, the present invention has axis parallel and need not be perpendicular to the horizontal plane in these embodiments.

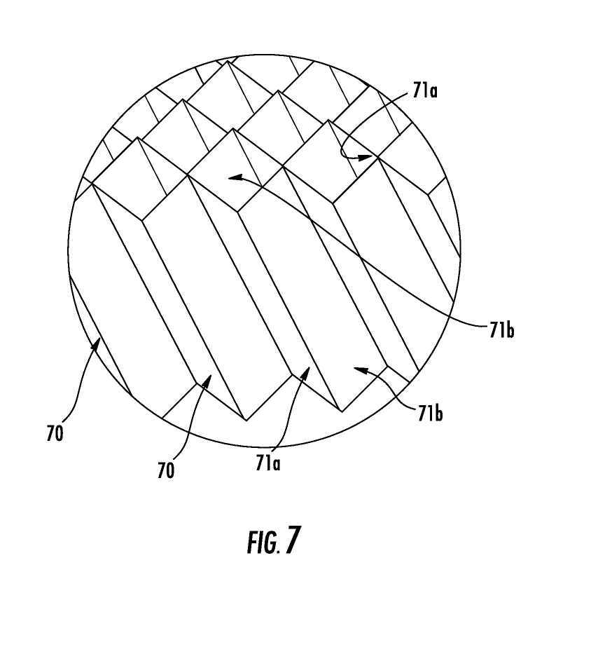

FIG. 5 depicts a saw tooth pattern with an accordion fold design having open ends like in FIG. 3 and FIG. 4 but with non-solid walls. It's possible that both sides of the device could be appropriately coated and utilized such that bottom walls 58 can also be of the invention when the device shown is turned bottom up. Once again, axis 59 are shown to be perpendicular. Note the axis is not through each wall 52 and 53 but the axis of the ridge formed by the two of them. V shaped bottom 54 is shown formed by the folds. Horizontal plane 59 is also shown. The top side optical clear highly specular surface is coated on the bottom reducing diffuse reflection.

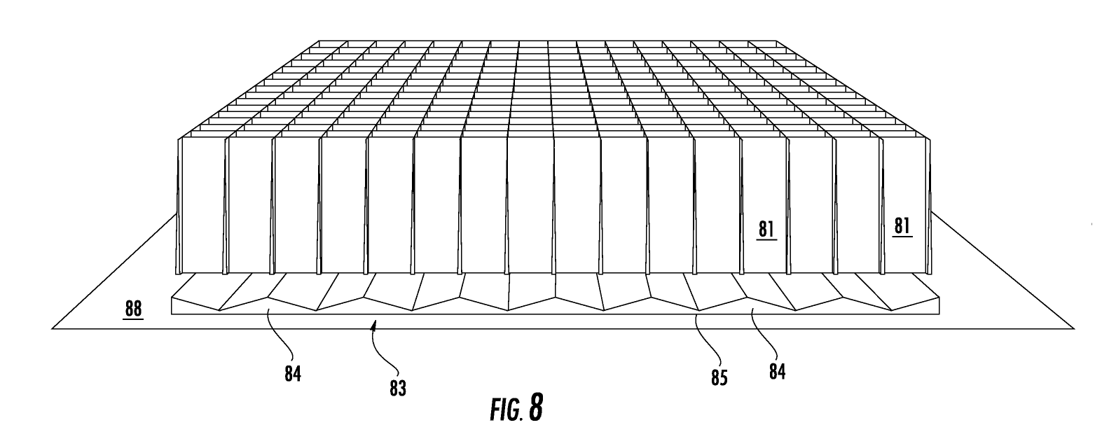

FIG. 6 shows a matrix of cells in perspective view that the sides are entirely enclosed. 4 sided cells are shown. In this matrix the cells are arranged in rows 51 and columns 52 in an aligned fashioned. The axis 68 are parallel and horizontal plane 69 is shown. The sharp top sides 54 are all on the same horizontal plane parallel to plane 69.

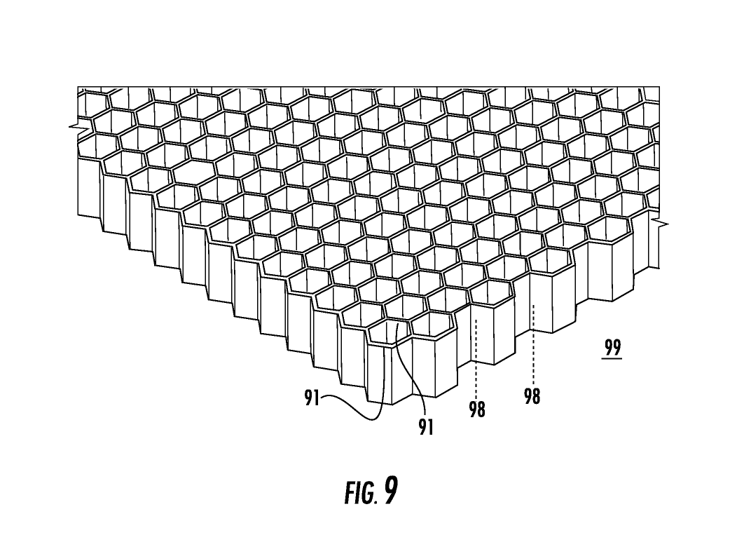

FIG. 7 shows cells 70 which are not in a perfect horizontal column row fashion. But still has 4 opposing walls 71a and 71b.

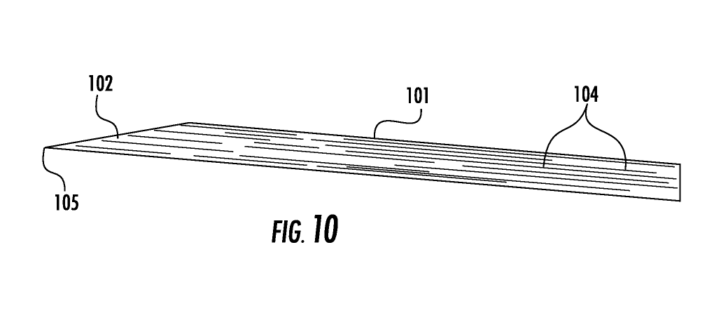

FIG. 8 depicts cells similar to those in FIG. 6, however, the cells axis are perpendicular to plane 88. The bottom to cells 81 are formed by sheet 83 which has ridges 84 and valleys 85 which create angled bottoms for each cell 81. To further reduce edge reflection the top of the ridge is placed under the sides and valley bottom is under cut. If undercut with a space, this allows contamination purging by external source clean air. In certain applications, the cells 81 are not utilized due to lack of room, for example room constraint with a camera lens aperture. It's shutter blades instead of a flat black surface is formed 84 in near microscopic pattern and is of a highly specular angled textured surfaces. An example of a camera lens opening all the light will strike the iris blade surface nearly face on the iris blades with the light reflecting off the angled surfaces skewing off axis for capture in the optical black lens housing. Likewise, the light reflection from the imager/filter's surface (for example a CCD or CMOS) will strike nearly face on the backside of the iris blades. Instead of flat black iris blades, comprised of angled specular black textured surfaces, the light will reflect off the specular black iris angled textured blade surfaces at abrupt angles for capture in the optical black lens housing or camera body. This design will minimize unwanted light returning to the camera imaging sensor. The surface besides as illustrated in base 84 can be multi axis to form pyramids or any other configuration as described herein. The pattern size can be formed from microscope to meters in size. To dramatically reduce the surface specular reflection and corner/edge reflections, anti-reflection coatings can be applied in single or multiple layers to minimize reflection over a wide frequency range and wide range of angles. The iris blade is just one example application but the surface texture, pattern and angle size with antireflection coating can be optimized for light absorption of the desired wavelength range with what little reflected light to be randomly dispersed or in a particular designed direction for minimal impact in a device's performance. The optical black lens housing could be an example of FIGS. 2, 3, 4, 6, 7, 8, 9, though example FIG. 4 and example FIG. 8 with only base 84 and anti-reflection coating on specular black angled surfaces could be of better advantage. A spiral (steep screw thread) pattern could simplify mold removal. The angled surfaces are optimized angles to avoid reflection directly or indirectly in the camera sensor. Some existing camera housings has ribbed flat black diffused surfaces without anti reflection coating.

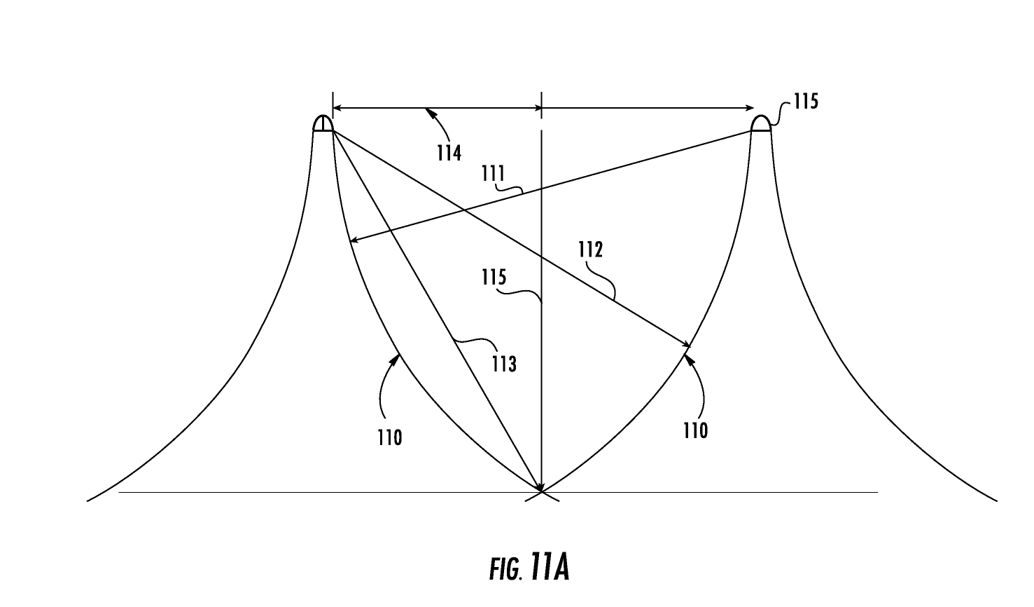

FIG. 9 shows a perspective view of cells 91 with hexagonal configuration for each set of cell walls 91. It can be seen that virtually any number of opposing sets of walls can be utilized in a matrix. The axis 98 are perpendicular to plane 99.

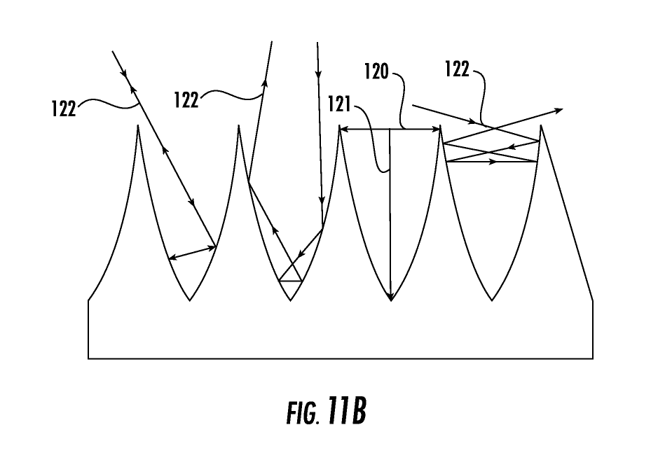

FIG. 10 shows a side view of a cell wall 101 wherein the material it is made from is a clear specular material 102 with black carbon fibers 104 imbedded below the surface in the wall 101. Sharp wall top 105 is clearly shown. In this case the carbon fibers should be open ended and not be rolled over toward the ends of the sharp top to prevent outward reflection off the sides of the fibers. Fibers should be oriented on one axis from the base of the cell going outward to prevent the sheen reflective like effect off the fiber sides outward. For radar absorption the fibers in one embodiment are not coupled to one another but insulated from one another and be of increasing (wave) length as going deeper into the blade offering absorption of microwave frequencies. The cell wall surfaces 101, 102 and 103 could be optically antireflection coated with a single or multi coatings to minimize specular and/or diffuse reflection for various wavelengths and angles.

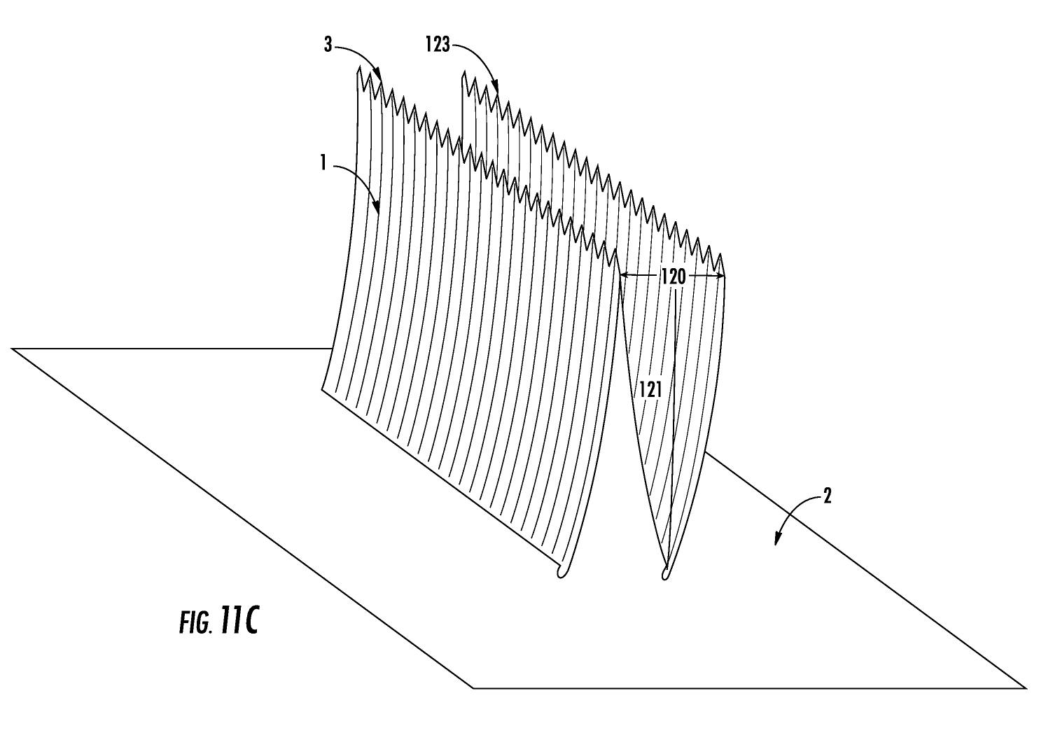

FIG. 11a is an example of the present invention where cell walls 110 are curved and not straight. Specular reflection is depicted in example arrows 111, 112, 113. In this embodiment essentially all reflecting will exit after 2 reflections in most cases greater than 98% of light is absorbed in general the width 114 to depth 115 is a ratio of 5 to 4.33. Note in this example rounded cell tops 115.

FIG. 11b is a side view example of the cell as in FIG. 11a, however, the width is smaller than the depth 121. In this embodiment specular reflection 122 will take in general three or more bounces before exiting the cell and thus have a much higher absorbance. FIG. 11c is a perspective view of the cell of FIG. 11b. Wherein saw tooth edge 213 which contributes to reduction of edge reflection shown.

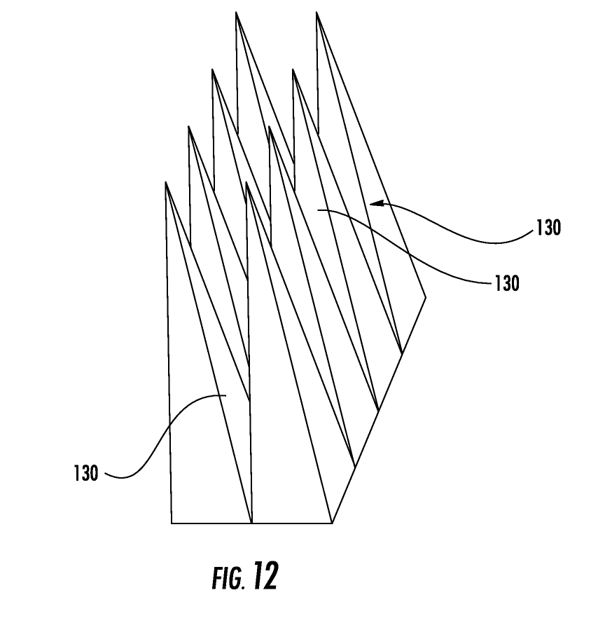

FIG. 12 is a perspective view of an embodiment of the invention wherein pyramid walls 130 create the reflective surface.

Those skilled in the art to which the present invention pertains, may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A device having an optical black surface for the absorption of electromagnetic energy having a wavelength between about 10 nm and about 1 meter comprising:
a) a matrix of cells each cell having at least two opposing walls, each opposing wall having a wall surface facing the inside of the cell each and a sharp top surface, each cell having a bottom and a depth;
b) the distance between the sharp top surface of the at least two opposing walls is no greater than 130% the depth;
c) a center axis of each wall facing in the same direction;
d) the wall surface and bottom of the cell being a black color and being of a specular and diffuse absorbing material generating mostly specular reflection; and
e) the bottom of the cell being of an angle other than perpendicular to the walls of the cell.

2. The device according to claim 1 wherein the top surface of the walls of all the cells of the device is planar.

3. The device according to claim 1 wherein the sharp straight edge top has a thickness of no greater than about 30% of the spacing between the walls.

4. The device according to claim 1 wherein the cells are arranged in a honeycomb pattern.

5. The device according to claim 1 wherein the cells are arranged in a saw tooth pattern.

6. The device according to claim 1 wherein the bottom of the cell is flat.

7. The device according to claim 1 wherein the bottom of the cell is angled from about 10 to about 80 degrees relative to a horizontal plane.

8. The device according to claim 1 wherein the bottom of the cell is a V shape.

9. The device according to claim 1 wherein the opposing walls are parallel.

10. The device according to claim 5 wherein the sharp top is sawtooth.

11. The device according to claim 10 wherein the sharp sawtooth edge top has a thickness of no greater than about 50% of the spacing between the walls.

12. The device wherein a matrix of cells each having a positive or negative shaped cone or pyramid or other shape of at least three to one height to width ratio.

13. The device according to claim 1 wherein the opposing walls of each cell are curved on a single or two axis.

14. The device according to claim 1 wherein the bottom of the cell is open.

15. The device according to claim 1 wherein the opposing walls are of multiple planar angles.

16. A device according to claim 1 wherein the surfaces are single or multiple antireflection coatings to minimize specular and diffuse reflection.

17. A device according to claim 1 wherein there is a specular surface comprising single or multi axis and patterns to reflect light in a particular direction or dispersed with an anti-reflection coating.
